(19) United States
(12) Patent Application Publication
(10) Pub. No.: US 2003/0182182 A1
(43) Pub. Date: Sep. 25, 2003

(54) Biometrics-based voting

(76) Inventor: Robert W. Kocher, Arlington, VA (US)

Correspondence Address: ROBERT W. KOCHER, 4828 3RD ST. NORTH, ARLINGTON, VA, 22203, US

(21) Appl. No.: 09/738,349

(22) Filed: Dec. 18, 2000

(51) Int. Cl. G06F 17/60

(52) U.S. Cl. 705/12

(57) ABSTRACT

A simplified computerized voting information system that encompasses voting through a voice communication system using the voter's voice in conjunction with their social security number, driver's license number, telephone number to verify the person and register their vote. This database will be used for registration of a person to vote. It contains a database of known records of a person such as a telephone directory which contain the person's name, phone number, address, social security number and driver's license number. This database is the main source which the system will verify a user's identity against. Using the “Caller Id” a function of most phone today, the computerized system will recognize the incoming phone number and register it in the system. Upon its registration of this phone number, it will enter into a verification mode where it will search for the person's record of telephone in the directory database until a match is found. Upon an affirmative match, the system will then ask the user to input their voice data by talking into the phone. The person will say their phone number. The computerized system will then record the voice data into a template. When the user decides to vote, he/she will call at the designated voting period. The computerized system will answer and ask for their social security number or telephone number etc. It will then record that voice data and compare it to the template. The system will locate that person's record by recognizing the actual numbers that the person states and search for that person's record. Upon successful location of that record, the system will locate the template and compare it to the recently spoken voice data. If the match is success, the voter will be permitted to vote and enter into the voting process.

### CROSS REFERENCE TO RELATED APPLICATIONS

Not Applicable

### STATEMENT REGUARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The purpose of the invention is to solve the problems of low attendance rates, inconvenience to voters in time and distance, increased accuracy (decreasing rejection rate), and fraud by more secure identification. The results of this invention will allow more people to vote who traditionally have not voted or view the current state of the art as too cumbersome.

Prior art for voting machines and systems contain time-consuming paper-based mechanisms or using electronic means with questionable security. U.S. Pat. No. 5,875,432 issued to Richard Sehr attempts to improve the voting process by using a smart card or voting card. This procedure requires card reader wherever the voter is located creating additional cost and complexity.

### BRIEF SUMMARY OF THE INVENTION

Our invention takes a new approach to solving the voting problems listed above by using biometric authentication in conjunction with existing communications media (telephones microphones, and computers) and electronic media databases of personal records. It also encourages attendance rates of voters because all the media above are common and easily used.

The combination of biometric authentication with our voting system creates a secure and easily accessible environment for voters. Our voting system consists of a voter ID (such as social security number and telephone number) to uniquely identify a person linked to their residential address and signature card. The biometric data such as voice would be expressed in the form of this unique ID. For example, the person would speak their social security number and telephone number into a telephone which would be stored in the database record. The voice data would then be used to authenticate the person's unique ID.

### BRIEF DESCRIPTION OF THE DRAWINGS

FIG. 1 is an overview of option available to the voter and automatic updating of databases.

FIG. 2 is the voter registration process.

FIG. 3 is the voting process.

FIG. 4 is voter initiated database changes.

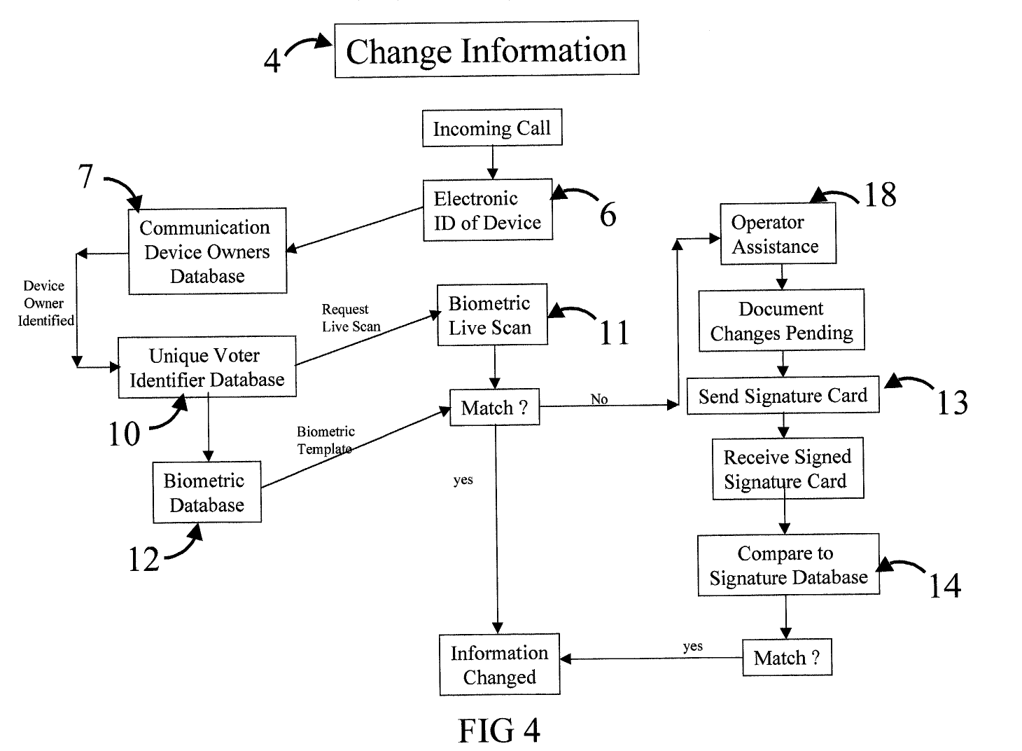

FIG. 5 is automatic input database changes.

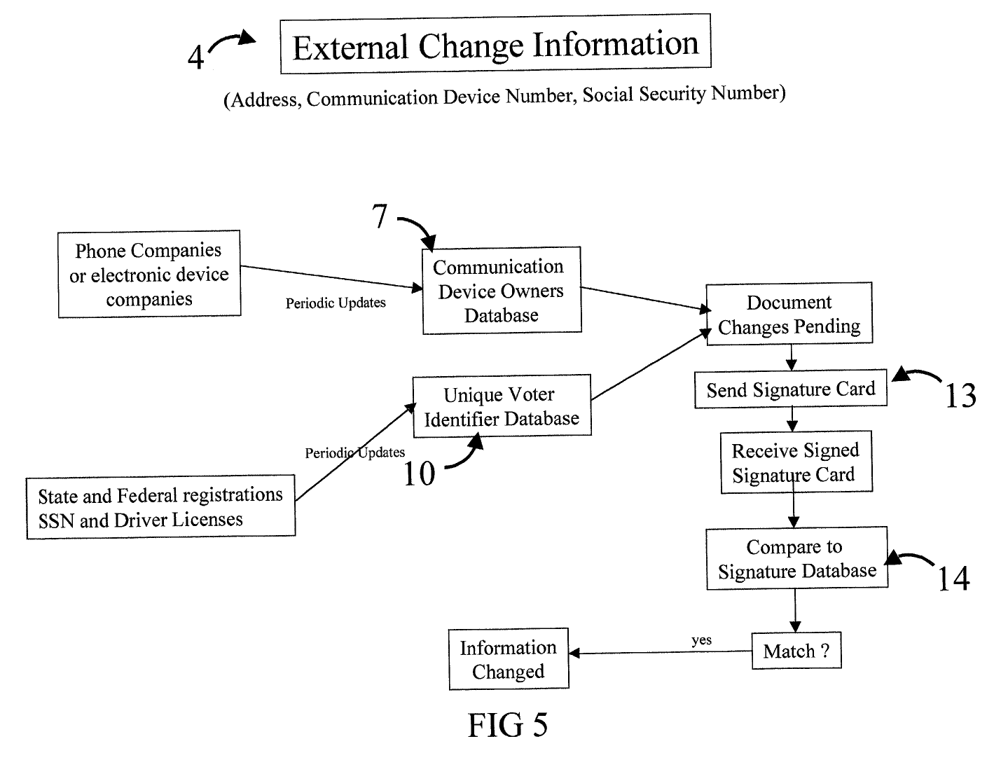

### LIST OF REFERENCE NUMERALS

Item 1 is the voter

Item 2 is the registration process

Item 3 is the voting process

Item 4 is the process for changing data

Item 5 is a communication device such as a telephone

Item 6 is an electronic identification system such as ‘caller ID’

Item 7 is the communication device owners identification database

Item 8 is the communication device electronic media

Item 9 a unique voter identifier such as the Social Security Number (SSN)

Item 10 is the unique voter identifier database

Item 11 is a voter's biometric live scan

Item 12 is a biometric database and repository

Item 13 is a signature card

Item 14 is the signature card database

Item 15 is the communication device ballot

Item 16 is a system for recording and tallying votes

Item 17 is an electronic voting center (EVC)

Item 18 is operator assistance

### DESCRIPTION OF PREFERRED EMBODIMENT

A simplified computerized voting information system that encompasses voting through a communication system using the voter's voice in conjunction with their social security number, driver's license number, or telephone number to verify the person and register their vote. This database will be used for registration of a person to vote. It contains a database of known records of a person such as a telephone directory which contain the person's name, phone number, address, social security number and driver's license number. This database is the main source from which the system will verify a user's identity against. Using the “Caller Id” a function of most telephone's phone today, the computerized system will recognize the incoming phone number and register it in the system. Upon its registration of this phone number, it will enter into a verification mode where it will search for the person's record of telephone in the directory database until a match is found. Upon an affirmative match, the system will then ask the user to input their voice data by talking into the phone. The person will say their phone number or social security number. The computerized system will then record the voice data into a template ending the computerized registration process. A signature card will then be sent to the address of record requesting the voter's signature which will be returned and kept of file for future changes.

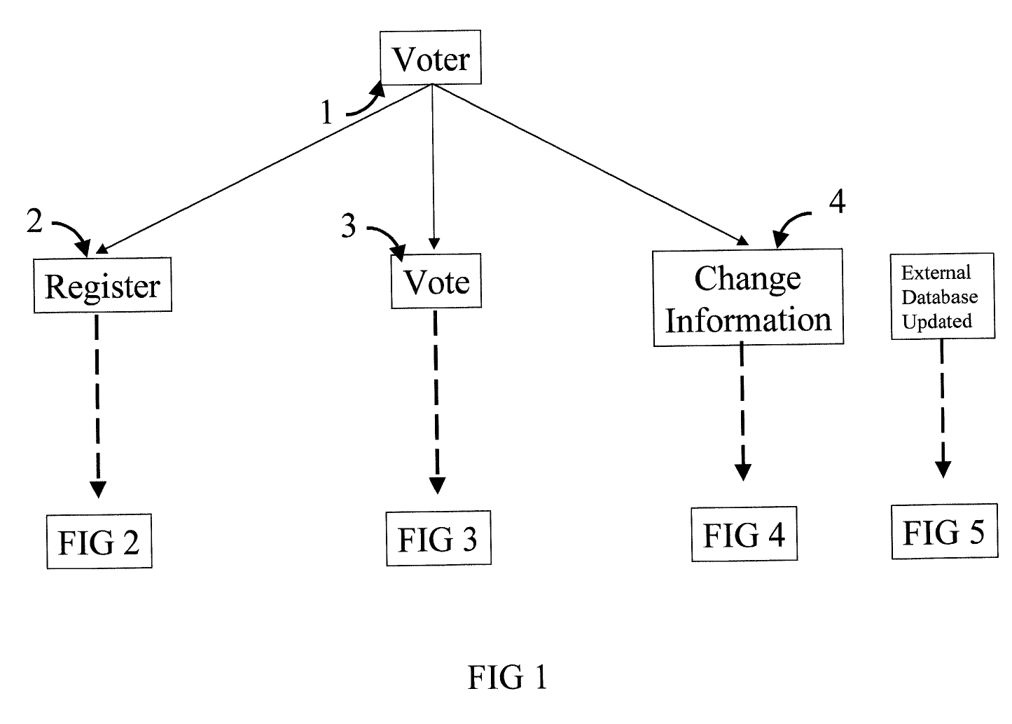

Voter Options (FIG. 1)

The voter 1 has three basic options to Register 2, to Vote 3 or to Change Information 4. Before the voter can vote, he must register 2 into the database.

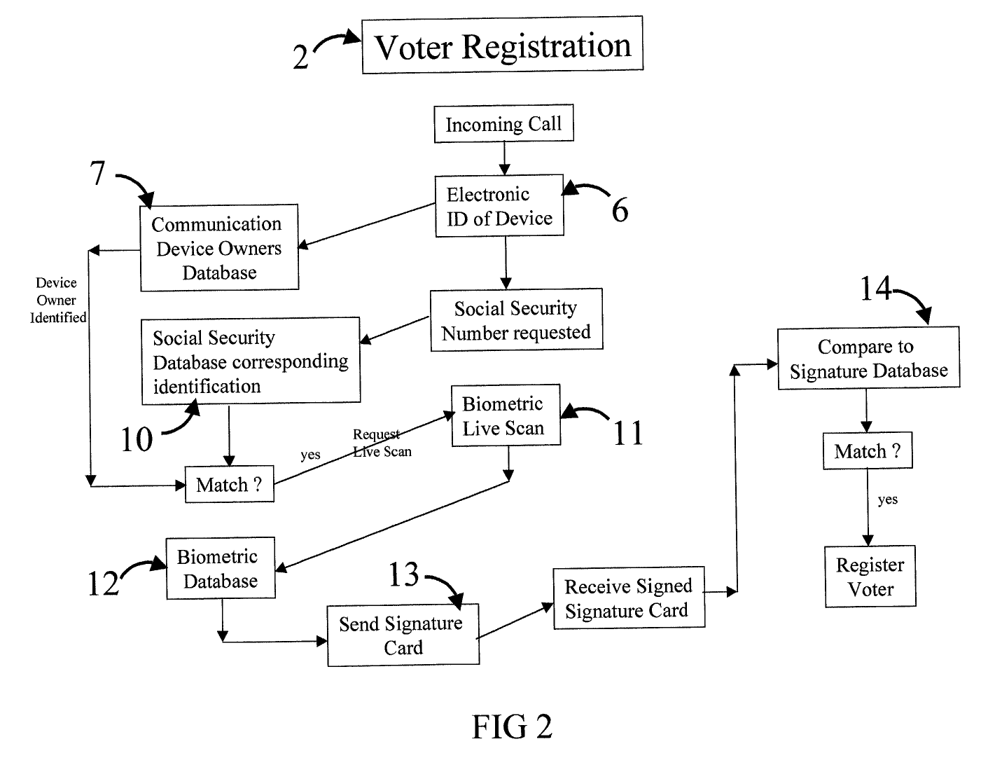

Voter Registration (FIG. 2)

The computerized registration system operates in the following logical order to initiate voter registration 2:

The system receives an incoming call from a communications device. The electronic identification (ID) of the communication device 6 is received by the system and processed into the Communications Device Owner's Database 7.

The ID is compared to a directory of Communications Device Owner's Database 7. If the directory has a match, the system goes forward. If not, it tells the user that they must register in the database first via written registration or digital signature 13 such as Public Key Infrastructure (PKI). The directory is then updated after receipt of the information.

The system requests the person to speak their social security number into the device 11. The SSN voice data is stored in a file. The file is converted into the numerical expression leaving a copy left for later analysis. The number is then compared to a directory of Social Security Database 10. If the directory has a match, the voice data is converted into a biometric template and is stored in the Biometric database 12.

Voice data is converted into a template usable for biometric analysis and stored in the database record. Person sends in a signature card which is compared to a signature database 14 which also may be digital. If there is a match, then voter is registered.

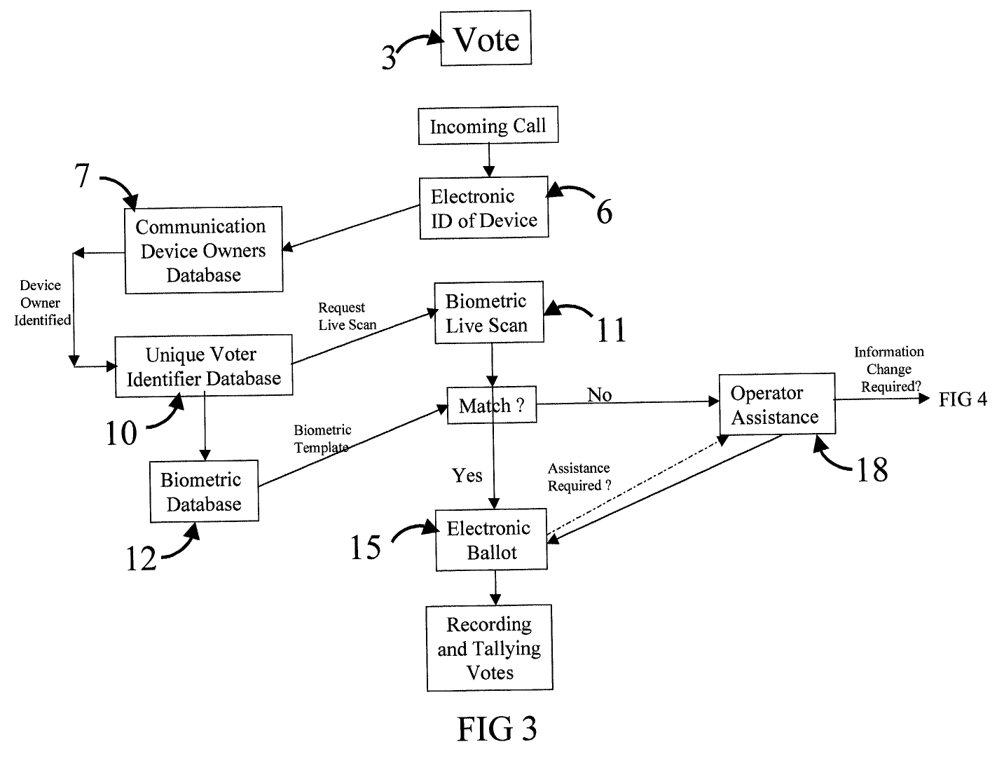

2. Voting Process (FIG. 3)

Voter will use communication device to vote 3. When the user decides to vote 3, he will call at the designated voting period. The system receives an incoming call from a communications device. The electronic identification (ID) of the communication device 6 is received by the system and processed into the Communications Device Owner's Database 7. The ID is compared to a directory of Communications Device Owner's Database 7. If the directory has a match, the system goes forward.

The computerized system will answer and ask for their social security number or telephone number. The system will locate that person's record by recognizing the actual numbers that the person states and search for that person's record in the Unique Voter Identifier Database 10. Upon successful location of that record, the system will attempt to verify the voter's identity by locating the template in the Biometric Database 12 and comparing it to the Biometric Live Scan 11. If the match is success, the voter will be permitted to vote and enter into the voting process and fill out an Electronic Ballot 15. If not, Operator Assistance 15 will intervene to process the voter.

3. Voter Initiated Database Changes

Voter will use communication device to change information 4. When the user decides to change information 4, he will call before the designated voting period. The system receives an incoming call from a communications device. The electronic identification (ID) of the communication device 6 is received by the system and processed into the Communications Device Owner's Database 7. The ID is compared to a directory of Communications Device Owner's Database 7. If the directory has a match, the system goes forward.

The computerized system will answer and ask for their social security number or telephone number. The system will locate that person's record by recognizing the actual numbers that the person states and search for that person's record in the Unique Voter Identifier Database 10. Upon successful location of that record, the system will attempt to verify the voter's identity by locating the template in the Biometric Database 12 and comparing it to the Biometric Live Scan 11. If the match is success, the voter will be permitted to change information. If not, Operator Assistance 18 will intervene to process the voter.

Automatic Input Database Changes

At periodic times, the Communication Device Owners Database 7 will be updated with current voter information such as name, address, and phone numbers. At periodic times, the Unique Voter Identifier Database 10 will be updated with current voter information such as addresses with Social Security Number and Driver License Numbers.

### ALTERNATE EMBODIMENTS

Alternate embodiments of this invention would incorporate various forms of biometrics, signatures such as digital signatures, and media. It is envisioned that this information would be stored in a repository containing a central databases of biometrics and voter information. Our invention would also be used in conjunction with current state of the art voting methods.

1. A method of electronic voting system comprising:
an eligible voter;
an electronic communication media device;
a database of unique identifiers of said electronic communication media device;
a unique voter identifier;
a database of said unique voter identifiers;
said eligible voter's biometric data;
a database of said eligible voter's biometric data;
an electronic communication voting ballot; and
a system for recording and tallying votes.

2. The electronic voting system of claim 1 wherein the communications media device is a telephone.

3. The electronic voting system of claim 1 wherein the unique voting identifier is a social security number.

4. The electronic voting system of claim 1 wherein the biometrics is a person's voice.

5. The electronic voting system of claim 1 wherein the biometrics is a subset from the list of fingerprint, face, iris, and hand.

6. The electronic voting system of claim 1 wherein the communication media means is the internet;

7. The electronic voting system of claim 1 wherein the communications device is a computer.

8. The electronic voting system of claim 1 wherein the communication language offered to the voter can be of multiple languages.

9. The electronic voting system of claim 1 wherein the said unique identifiers include a digital signature.
